(19) United States
(12) Patent Application Publication
(10) Pub. No.: US 2025/0378367 A1
(43) Pub. Date: Dec. 11, 2025

(54) OUT-OF-DISTRIBUTION PREDICTION

(71) Applicant: Citigroup Inc., New York, NY (US)

(72) Inventors: Alberto Cetoli, London (GB); Minjeong Cho, London (GB); Jason Ryan Engelbrecht, London (GB); Ines Teixeira, London (GB)

(21) Appl. No.: 18/736,407

(22) Filed: Jun. 6, 2024

(51) Int. Cl. G06N 20/00

(52) U.S. Cl. CPC G06N 20/00

(57) ABSTRACT

A set of features of a training document are identified in a training document for training a machine learning model. A subset of the features is selected to be omitted from a training forward propagation. As a result of omitting the subset of the set of features, a different subset of the set of features is used to train the machine learning model to classify documents and distinguish between an out-of-domain document and in-domain document.

### BACKGROUND

A machine learning system may provide inaccurate information when presented with documents that are out-of-distribution from the types of documents used to train the machine learning model. For example, current machine learning systems may misclassify documents that have similarities to, but are actually different from, documents in the training data. This occurs partly because the prediction capabilities of current machine learning models are limited by the initial training data, which result in machine learning models that give too much weight to less-significant features in the data.

### BRIEF DESCRIPTION OF THE DRAWINGS

Various techniques will be described with reference to the drawings, in which:

FIG. 1 illustrates an example of an overview of an out-of-distribution prediction system, in accordance with an embodiment;

FIG. 2 illustrates an example of a classification system, in accordance with an embodiment;

FIG. 3 illustrates an example of visual token mask masking, in accordance with an embodiment;

FIG. 4 illustrates an example of visual patch mask masking, in accordance with an embodiment;

FIG. 5 illustrates an example an out-of-distribution and outlier prediction system, in accordance with an embodiment;

FIG. 6 is a flowchart that illustrates an example of an out-of-distribution prediction system that trains a machine learning model to identify whether a data object is out-of-distribution, in accordance with an embodiment;

FIG. 7 illustrates an application programming interface that returns an out-of-distribution prediction, in accordance with an embodiment; and

FIG. 8 illustrates an example of a computing device that may be used in accordance with at least one embodiment/an environment in which various embodiments can be implemented.

### DETAILED DESCRIPTION

The present application describes systems and techniques to determine whether input data of a machine learning model is out-of-distribution data, by training a machine learning (ML) model with masked training data and providing masked input data to the trained machine learning model. Users of the systems may mistakenly upload input data that includes irrelevant documents that are significantly different to “in domain” data, which the machine learning model has been trained to predict. In this disclosure, a robust outlier detection is implemented that allows an out-of-distribution system to identify such outliers and subsequently send the outliers for manual review. In at least one embodiment, an out-of-distribution system detects outlier data by randomly masking portions of training data, which results in a machine learning model that assigns more weight to the most important features in the data. In at least one embodiment, the masking of training data results in a greater difference between vectors of relevant data versus irrelevant data, making it easier to identify when irrelevant data, such as an incorrect document, is input into the machine learning model.

In at least one embodiment, a system extracts features from a training document for training a machine learning model. Further in the embodiment, the system selects a portion of these features to omit (e.g., mask) from a training forward propagation. Then, in the embodiment, the system trains the machine learning model to produce a trained machine learning model using a different set of features that have not been masked. In at least one embodiment, the trained machine learning model output information that may be used to classify documents and distinguish between an out-of-distribution document and an in-domain document.

In at least one embodiment, a system masks portion of training data to produce mask training data where the mask training data includes both in-domain data and out-of-distribution data. Further in the embodiment, the system trains a machine learning model using the masked training data to produce a trained machine learning model. Then, in the embodiment, the system receives input data to be classified by the trained machine learning model and masks input data to produce masked input data. Then, in the embodiment, the system provides the masked input data to the machine learning model. Finally, as a result of providing the masked input data to the machine learning model, the system receives, as an output of the machine learning model, a classification of the input data and determines, based on the classification, that the input data is out-of-distribution data.

In at least one embodiment, the training data used to train the machine learning model includes both in-distribution data and out-of-distribution data. The terms “in-distribution,” “in-domain,” and “ID” are used interchangeably in the present disclosure and are intended to have corresponding scope. Similarly, the terms “out-of-distribution,” “out-of-domain,” and “OOD” are likewise used interchangeably in the present disclosure and are intended to have corresponding scope. In at least one embodiment, the training data includes at least one of plaintext, image, or layout features. In at least one embodiment, the training data may include a combination of either of the plaintext, image, or layout features. In at least one embodiment, a training procedure to train the machine learning model brings embeddings of similar classes closer together and embeddings of dissimilar classes further apart.

In at least one embodiment, the masking of training or input data corresponding to plaintext data may include token text masking. For example, a random sentence may be tokenized with random masked tokens and encoded using attention masking. In another example, a random sentence may be tokenized with random masked tokens and padding. The tokenized sentence may then be encoded using attention masking that includes the padded tokens. In at least one embodiment, the padding of tokens may be added to the end of tokenized sentence of a particular length. The padding is added at least because the particular length of the sentence may be less that the length of an encoding model that is being used by the out-of-distribution prediction system. In at least one embodiment, an attention score of the attention mask with padding indicates which token should be active in training the machine learning model and/or generating predictions by the machine learning model. For example, the attention score indicates tokens corresponding to the sentence length which are active, and the rest of the padding tokens should be zero.

In at least one embodiment, the system determines which portions of the training data to mask for the machine learning model using pseudorandom process. In at least one embodiment, the system determines portions of the training data to mask based on a parameter value, obtained by the system, that indicates a specified size or number of portions of the training data to be masked. In at least one embodiment, the system masks portions of training data based on the parameter. In at least one embodiment, the system obtains the parameter from a user of the system. In at least one embodiment, the system masks portions of training and/or input data based a consistent (e.g., same) position or region in the text and/or image pixels. In another embodiment, the system masks portions of training and input data based on selective masking of important features learned by the machine learning model. For example, the system may determine particular features from the encoding layers of the machine learning model information and aggregate the information to identify which features were activated (e.g., repeatedly identified as contributing towards making correct predictions), and then masking/omitting one or more of those features.

In at least one embodiment, the system determines that the input data is out of distribution by using at least one of a confidence score (also referred to as a confidence measure) or a multivariate distance metric, alternatively known as a distance metric or a distance metric. In at least one embodiment, the confidence score may be generated by defining boundaries of a distribution of confidence scores of classes using the masked training data. In at least one embodiment, during inferencing operations, a masked dense vector of a new document is compared to a threshold value of the confidence scores to determine if the new document is an out-of-distribution document. In at least one embodiment, the distance metric may be generated using attention and/or self-attention. For example, a sentence or word embedding may be processed by an attention-based network to learn feature representation of contexts. In at least one embodiment, in token text masking an attention mask may be used to indicate which token are padding, by placing “0s” in those positions, and placing “1s” in positions that should be attended to. In at least one embodiment, the system determines that the input data is out-of-distribution by comparing a dense vector associated with the masked input data to another dense vector associated with the masked training data. In at least one embodiment, the dense vectors are extracted from the plaintext data or image data. In at least one embodiment, the dense vectors are based on features of plaintext, or images extracted from encoding layers. In at least one embodiment, input data determined to be out-of-distribution is an unexpected prediction, also known as an outlier prediction. For example, the system can extract a dense embedding vector of an input document and then compare this to the dense embedding vectors that have been extracted from the masking of the training data, and then get the distance cost which can be used to generate predictions and determine whether an input document is out-of-distribution or an outlier. In at least one embodiment, a document may be out-of-distribution if the data is significantly different from what the machine learning model is trained to predict. In at least one embodiment, an outlier, alternatively known as an outlier document, is a data point that significantly deviates from a distribution of data points. In some embodiments, the system determines an outlier if the data point is below a specified confidence score of predictions learned during training of the machine learning model. In at least one embodiment, the outlier may be detected by the system if the machine learning model outputs a prediction that is an unexpected data point relative to expected classifications of in-domain data and/or out-of-distribution data. In at least one embodiment, an outlier may be identified by the machine learning model performing outlier analysis. In at least one embodiment, an outlier may result from a user of the system uploading a document in error that is not relevant for a particular machine learning operation. In at least one embodiment, an outlier that is detected by the machine learning model may be sent to a client device for manual review. In at least one embodiment, as a result of the system determining that the input data is out-of-distribution data, the system causes the input data to be manually reviewed.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Techniques described and suggested in the present disclosure improve the field of computing, especially the field of machine learning, by generating predictions of input data is out-of-distribution using token masking and patch masking. Additionally, techniques described and suggested in the present disclosure improve the efficiency/functioning of computing systems performing machine learning by reducing the amount of irrelevant or out-of-distribution data being used to train the machine learning model. Moreover, techniques described and suggested in the present disclosure are necessarily rooted in computer technology in order to overcome problems specifically arising with the computing resources required by machine learning models to generate predictions and detect outliers that are irrelevant to the machine learning model operations and send the outliers for manual review.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Any system or apparatus feature as described herein may also be provided as a method feature, and vice versa. System and/or apparatus aspects described functionally (including means plus function features) may be expressed alternatively in terms of their corresponding structure, such as a suitably programmed processor and associated memory. It should also be appreciated that particular combinations of the various features described and defined in any aspects of the present disclosure can be implemented and/or supplied and/or used independently.

The present disclosure also provides computer programs and computer program products comprising software code adapted, when executed on a data processing apparatus, to perform any of the methods and/or for embodying any of the apparatus and system features described herein, including any or all of the component steps of any method. The present disclosure also provides a computer or computing system (including networked or distributed systems) having an operating system that supports a computer program for carrying out any of the methods described herein and/or for embodying any of the apparatus or system features described herein. The present disclosure also provides a computer readable media having stored thereon any one or more of the computer programs aforesaid. The present disclosure extends to methods and/or apparatus and/or systems as herein described with reference to the accompanying drawings. To further describe the present technology, examples are now provided with reference to the figures.

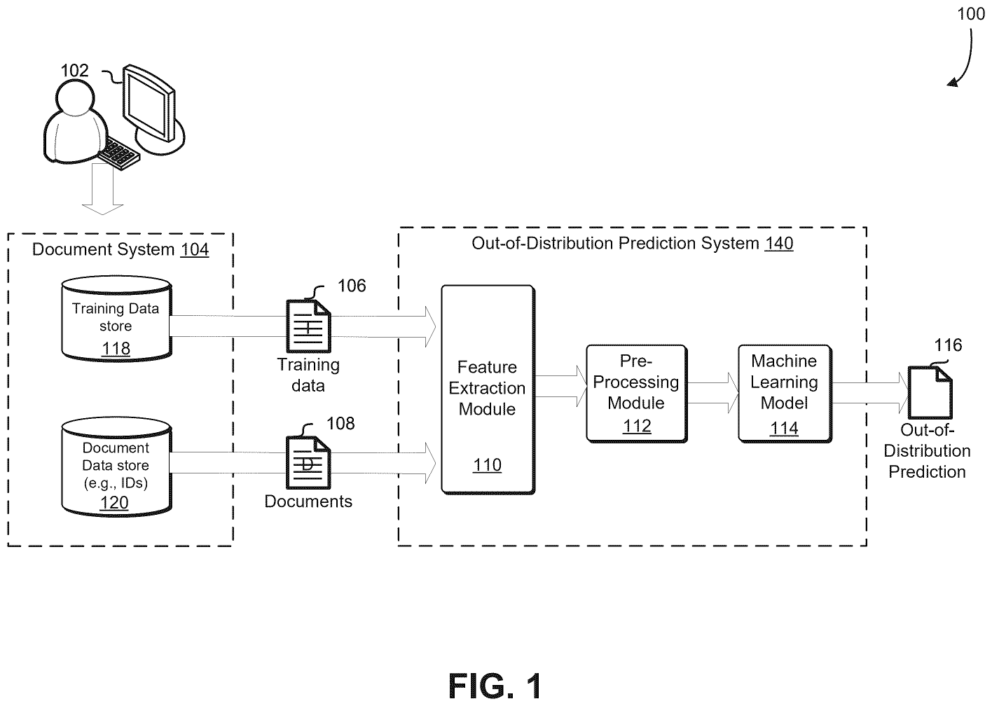

FIG. 1 illustrates an aspect of an environment 100 for an out-of-distribution prediction system 140 in which an embodiment may be practiced. In some embodiments, users 102 of this environment 100 include but are not limited to client users of the out-of-distribution prediction system 140. In at least one embodiment, as illustrated in FIG. 1, the environment 100 includes an out-of-distribution prediction system 140 as described herein, that receives a training document of training data 106 that may be used to train a machine learning model 114. In at least one embodiment, a feature extraction module 110 identifies and extracts relevant features of the training data 106 or input data, such as documents 108, to be further processed (e.g., encoding, embedding, and/or masking) by a pre-processing module 112, and then provided to the machine learning model 114. In at least one embodiment, the out-of-distribution prediction system 140 receives documents 108 as input data to the machine learning model 114, and generates, as an output of the machine learning model 114, an out-of-distribution prediction 116. The terms “documents” and “document” may be used interchangeably in the present disclosure where the scope of the embodiment can include “one or more documents.”

In at least one embodiment, the user 102 of this environment 100 include but are not limited to client users of the out-of-distribution prediction 140. In at least one embodiment, the user 102 may be an individual, a computing system, an executing software application, a computing service, a computing resource, or other entity capable of controlling input to and receiving output from the out-of-distribution prediction 140. The user 102 may have access to a set of user records and/or a profile with the out-of-distribution prediction 140, and may have a set of credentials (e.g., username, password, etc.) registered with the out-of-distribution prediction 140. In at least one embodiment, user 102 presents, or otherwise proves, the possession of security credentials, such as by inputting a password, access key, and/or digital signature, to gain access to out-of-distribution prediction. In at least one embodiment, the user 102 creates, using a user device or other computing device, an account with the out-of-distribution prediction 140. In at least one embodiment, user 102 uploads documents 108 to the out-of-distribution prediction system 140 causing the machine learning model 114 to generate a prediction 116 of whether the documents 108 are in-distribution or out-of-distribution. For example, the machine learning model expects a specific type of data when it is being trained to perform operations. In at least one embodiment, if a user 102 uploads a document that is an “unexpected” document (e.g., a driver's license, when the model is being trained to distinguish passports from national identity documents (IDs)), the machine learning model 114 may generate an out-of-distribution prediction 116 that the unexpected document is an outlier or an unknown document to in distribution documents.

In at least one embodiment, the document system 104 includes a training data store 118 and document data store 120. In at least one embodiment, the document system 104 is a repository providing non-transitory and persistent (non-volatile) storage for data objects. Examples of data stores include file systems, relational databases, non-relational databases, object-oriented databases, comma delimited files, and other files. In some implementations, the document system 104 comprises is a distributed data store. In at least one embodiment, the training data store 118 may store training data 106 and information related to in-distribution data and out-of-distribution data. In at least one embodiment, the document data store 120 may store documents 108 and information related to user documents (e.g., IDs, passports, or driver's licenses).

In at least one embodiment, training data 106 may be maintained in the training data store 118 and located, processed, and provided for use in processing by the out-of-distribution system 140 for training the machine learning model 114. For example, training data 106 may include, but is not limited to, a document bundles, national identification, driver's license, or passports. In at least one embodiment, each page of training data 106, may be independently processed separately from other pages. In at least one embodiment, each page of training data 106 may be processed as a whole with all pages included.

In at least one embodiment, documents 108 may be maintained in the document data store 120 and located, processed, and provided for use in processing by the out-of-distribution system 140, as input, to the machine learning model 114 to perform inferencing operations. For example, documents 108 may include, but is not limited to, a document bundles, national identification, driver's license, or passports. In at least one embodiment, each page of a document, such as document 108, may be independently processed separately from other pages. In at least one embodiment, each document, such as document 108, may be processed as a whole with all pages included.

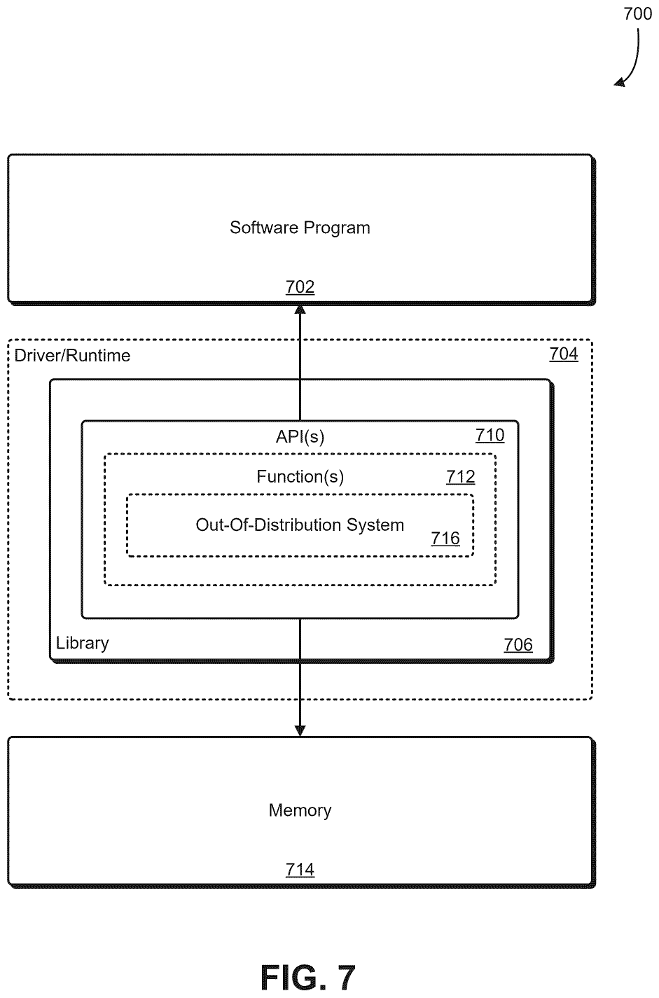

In at least one embodiment, a feature extraction module 110 may include an encoder that encodes input data to a machine learning module 114, such as training data 106 or documents 108, into one or more feature vectors. In at least one embodiment, an encoder of the feature extraction module 110 encodes training data 106 and/or document 108 into a sentence embedding vector. In at least one embodiment, a processor uses this sentencing embedding vector to perform a nearest neighbor search to generate one or more neighbors. In at least one embodiment, one or more neighbors is a value corresponding to a key comprising training data 106 or documents 108. In at least one embodiment, one or more neighbors comprise plaintext data. In at least one embodiment, an encoder of the feature extraction module 110 encodes one or more neighbors into a text embedding vector. In at least one embodiment, encoder of the feature extraction module 110 encodes one or more neighbors into a sentence embedding vector. In at least one embodiment, machine learning model 114 uses training data 106 and/or documents 108 to generate a prediction, such as out-of-distribution prediction 116. In at least one embodiment, a processor of a client device interfaces with an application of the out-of-distribution system 140 using a machine learning (ML) model application programming interface(s) (API(s)), such as API 710 in FIG. 7. In at least one embodiment, the processor accesses the machine learning model 114 using the machine learning model application programming interface(s) (API(s)).

In at least one embodiment, the pre-processing module 112 may be a computing system, software, software program, hardware device, module, or component capable of performing the masking of training data 106 and/or input data, such as documents 108, to generate masked training data and/or masked input data, respectively. In at least one embodiment, further in the embodiment, the masked training data is provided to the machine learning model 114 to perform training operations of the machine learning model 114, and the masked input data is provided to the machine learning model 114 to perform inferencing operations associated with classifications and predictions of whether documents 108 are out-of-distribution 116.

In at least one embodiment, parts, methods and/or systems described in connection with FIG. 1 are as further illustrated non-exclusively in any of FIGS. 1-8.

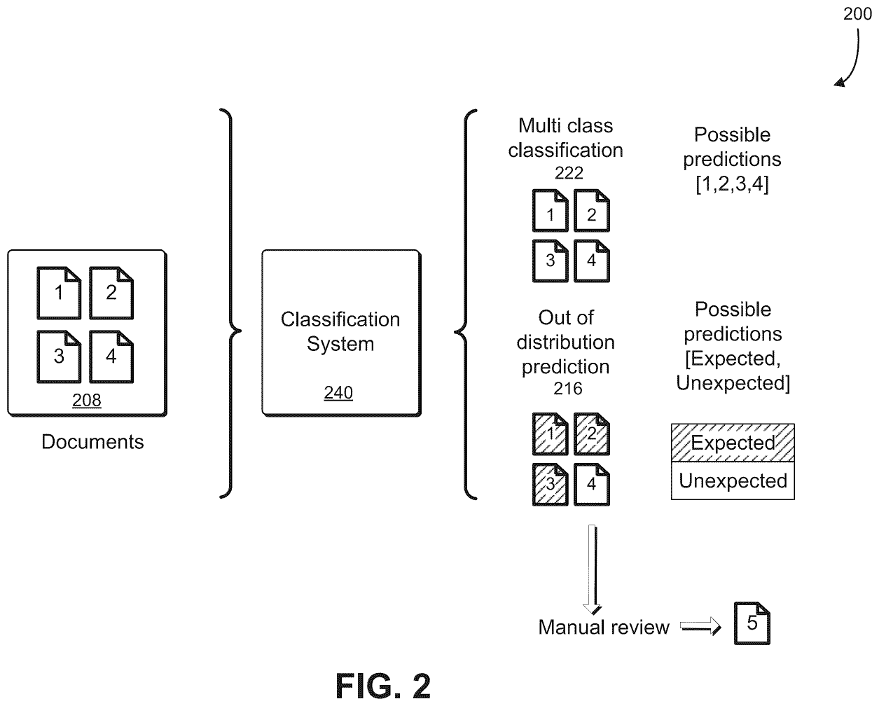

FIG. 2 illustrates an example of a classification system, in accordance with an embodiment. As illustrated in FIG. 2, the example 200 includes a classification system 240, such as the out-of-distribution prediction system 104, that receives documents 208 (including documents #1-4) and makes a prediction, such as an out-of-distribution prediction 216, with a machine learning model, such as machine learning model 114 in FIG. 1. In at least one embodiment, if the out-of-distribution prediction 216 of a document is an unexpected prediction, for example, document #4 of the documents 208 is unknown in the in-distribution documents, this document may be sent for manual review.

In at least one embodiment, the classification system 240 generates a classification of a document. For example, the classification system may be used to distinguish between of national identifications (IDs) and a passport. In at least one embodiment, if the classification system 240 receives documents 208, from a user of the system, such as user 102 in FIG. 1, the classification system 240 may classify the documents as a passport or an ID and obtain an associated confidence score with that decision. In at least one embodiment, a processor of the classification system 240 performs operations to compare the confidence score to a threshold value. In at least one embodiment, the threshold value is determined by using training data, such as training data 106 in FIG. 1.

In at least one embodiment, the classification system 240 generates a prediction of the classification of the documents 208. In at least one embodiment, the classification system 240 is automated classification library that enables multi-class classification 222. In at least one embodiment, the automated classification library is data agnostic. In at least one embodiment, the classification system 240 classifies documents 208 by simultaneously performing image patch and text token masking during the training of a machine learning model, such as machine learning model 114 in FIG. 1. In at least one embodiment, as a result of simultaneous image patch and text token masking during training, the machine learning model may learn the majority of important features for each class. In at least one embodiment, the prediction may be expected or unexpected. In at least one embodiment, if the prediction is expected, the document is consistent with the in-domain data. In at least one embodiment, if the prediction is unexpected, the document is consistent with the out-of-domain data and may be sent out for manual review. In at least one embodiment, the classification system 240 may cause a user of the system, such as user 102 in FIG. 1, to perform a manual review of the unexpected document or outlier.

In at least one embodiment, parts, methods and/or systems described in connection with FIG. 2 are as further illustrated non-exclusively in any of FIGS. 1-8.

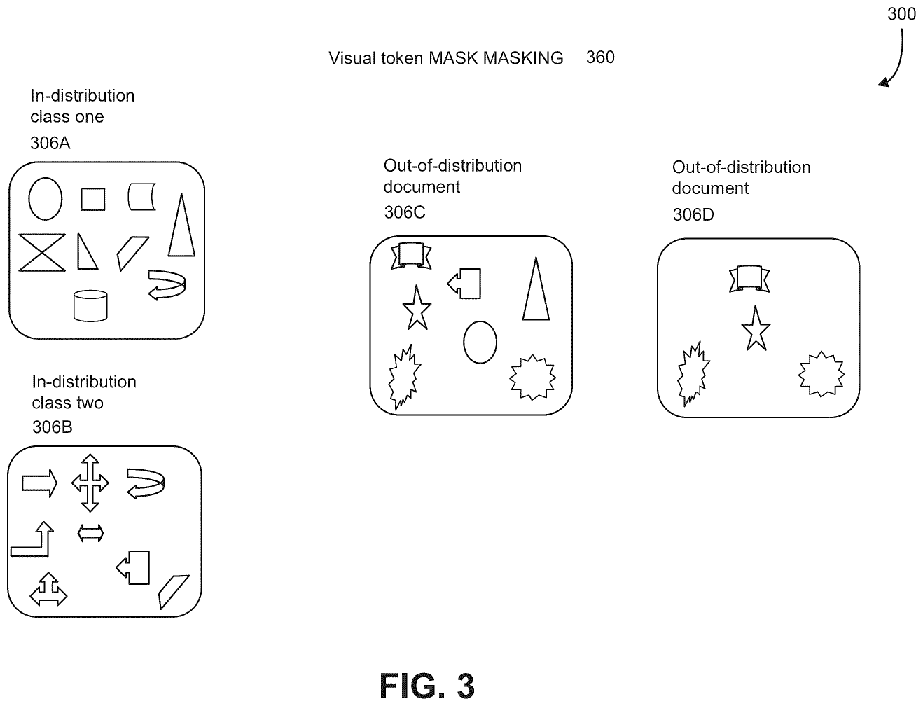

FIG. 3 illustrates an example 300 of visual token mask masking, in accordance with an embodiment. In at least one embodiment, this visual token masking includes in-distribution class one 306A, in-distribution class two 306B, out-of-distribution document 306C, and out-of-distribution document 306D that are used to train a machine learning model to distinguish between an in-domain document and out-of-distribution document (or outlier document). Each of the in-distribution class one 306A, the in-distribution class two 306B, the out-of-distribution document 306C, and the out-of-distribution document 306D include various shapes (e.g., an oval, a square, and a triangle) that represent features (e.g., tokens) of documents, such as training document 106 and/or documents 108 in FIG. 1, that are to be translated into dense vector embeddings for training the machine learning model.

In at least one embodiment, an out-of-distribution prediction system may translate each of the features of the in-distribution class one 306A and the features of the in-distribution class two 306B into a dense vector that is used to train a machine learning model. In at least one embodiment, in-distribution class one 306A represents a document including features that correspond to a classification of a document that is in-domain or alternatively known as in-distribution. As an example, this classification may identify a document as a passport. In at least one embodiment, in-distribution class two 306B represents a document including features that correspond to a different classification of another document that is in-domain. In this example, this different classification may identify a document as a national identification.

In at least one embodiment, the out-of-distribution prediction system may translate each of the features of the out-of-distribution document 306C and the features of the out-of-distribution document 306D into a dense vector that is used to train a machine learning model. In at least one embodiment, the out-of-distribution document 306C represents a document including features that correspond to a document that is out-of-distribution. In at least one embodiment, a As an example, the out-of-distribution document 306C may be used as input to a machine learning model that outputs a prediction that this out-of-distribution document 306C is not in-domain. In at least one embodiment, out-of-distribution document 306D represents another document including a different set of features that correspond to a document that is out-of-distribution.

In at least one embodiment, the in-distribution class one 306A and the in-distribution class two 306B represent documents of in-domain data. For example, in-domain data may be data that a machine learning model is being trained to classify (e.g., passports versus a national identity document). In at least one embodiment, the out-of-distribution document 306C and out-of-distribution document 306D represent a “foreign” or unknown document relative to the in-domain documents that the machine learning model is being trained to classify. In at least one embodiment, as a result of the masking, the machine learning model may be more robust at identifying in-domain documents (e.g., in-distribution class one 306A and the in-distribution class two 306B). For example, the machine learning model is able to classify documents as in-domain or in-distribution that have more similar features to the original in-distribution documents used to train the model than to the original out-of-distribution documents (used to train the model).

In at least one embodiment, a processor of the out-of-distribution prediction system masks image data during training to make the machine learning model more robust to a variety of features, such as described above. In at least one embodiment, the processor masks image data of input data (e.g., a passport or national identity document) during inferencing.

In at least one embodiment, parts, methods and/or systems described in connection with FIG. 3 are as further illustrated non-exclusively in any of FIGS. 1-8.

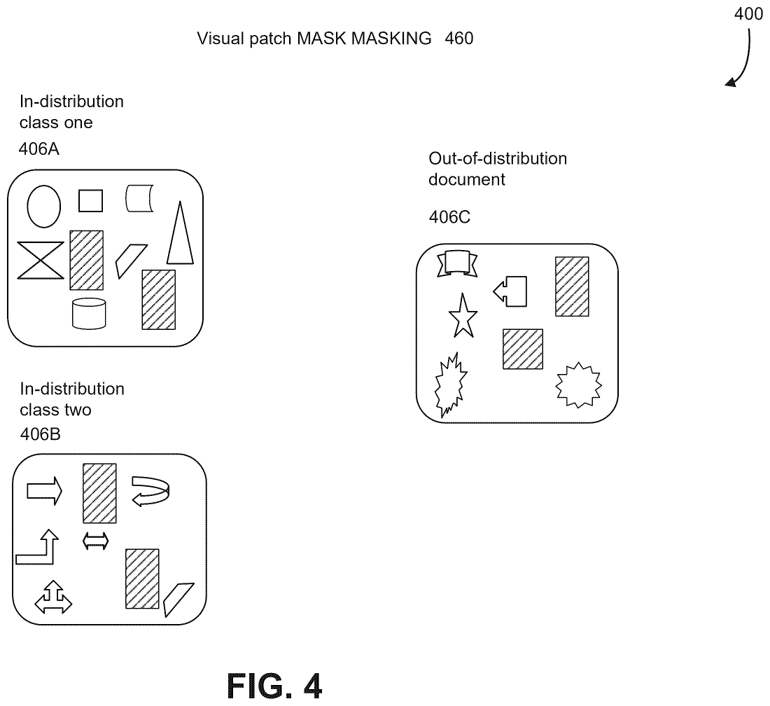

FIG. 4 illustrates an example 400 of visual patch mask masking, in accordance with an embodiment. In at least one embodiment, this visual patch mask masking includes in-distribution class one 406A, in-distribution class two 406B, and out-of-distribution document 406C that are used to train a machine learning model to distinguish between an in-domain document and out-of-distribution document or outlier document. Each of the in-distribution class one 406A, the in-distribution class two 406B, and the out-of-distribution document simple 406C include various shapes that represent features (e.g., tokens) of documents, some of the shapes are overlaid with a “patch” to mask or omit the corresponding features from those features to be used for training the machine learning model. In at least one embodiment, each feature map pixel may be a token. In at least one embodiment, the patch that overlays one or more features of training document or document to be classified is a computer-generated geometric shape. In at least one embodiment, the computer-generated shape obfuscates one or more features of a training document or document to be classified by the machine learning model. In at least one embodiment, the system translates the features into dense vector embeddings for training the machine learning model, the features lacking those that were omitted by using the patch mask masking.

In at least one embodiment, the out-of-distribution prediction system may translate each of the features of the in-distribution class one 406A and the features of the in-distribution class two 406B into a dense vector that is used to train the machine learning model. In at least one embodiment, the system used masking of features in training documents (and documents for inferencing, not shown in FIG. 4) to increase the distance between learned dense embeddings of out-of-distribution data from in-distribution data. As an example, by masking the feature that resembles a rectangular shape with an arrow facing in the left direction in-distribution class one 406B the In at least one embodiment and masking the features that resemble an oval and an equilateral triangle in out-of-distribution document 406C, results in in-distribution classes and out-of-distribution documents that do not share any features in common. In at least one embodiment, the system omits or masks features in documents for training machine learning models to create more robust trained machine learning models. In at least one embodiment, in-distribution class one 406A represents a document including features that correspond to a classification of a document that is in-domain. In at least one embodiment, in-distribution class two 406B represents a document including features that correspond to a different classification of another document that is in-domain.

Not shown in FIGS. 3 and 4 is token “text” masking. For example, the features (e.g., shapes) may represent tokens from a random sentence to be used in an array. In at least one embodiment, token text matching may implement feature extraction and feature masking to train a machine learning model to distinguish in-domain documents from out-of-domain documents. In at least one embodiment, the system performs image patch masking and text token matching simultaneously during training of the machine learning model. The simultaneous patch and text token masking allows for more separation in the extracted dense vectors between the in-domain and out-of-distribution data, as out-of-distribution data is dissimilar to the in-domain data and thus have less relevant features. In at least one embodiment, token text masking comprises attention masking to inform the machine learning model which tokens are padding, and which tokens are to be processed.

In at least one embodiment, a processor of a computer system of the out-of-distribution prediction system, such as out-of-distribution prediction system 140 in FIG. 1, may perform masking of image data or text image (not shown in FIG. 3 or 4). In at least one embodiment, parts, methods and/or systems described in connection with FIG. 4 are as further illustrated non-exclusively in any of FIGS. 1-8.

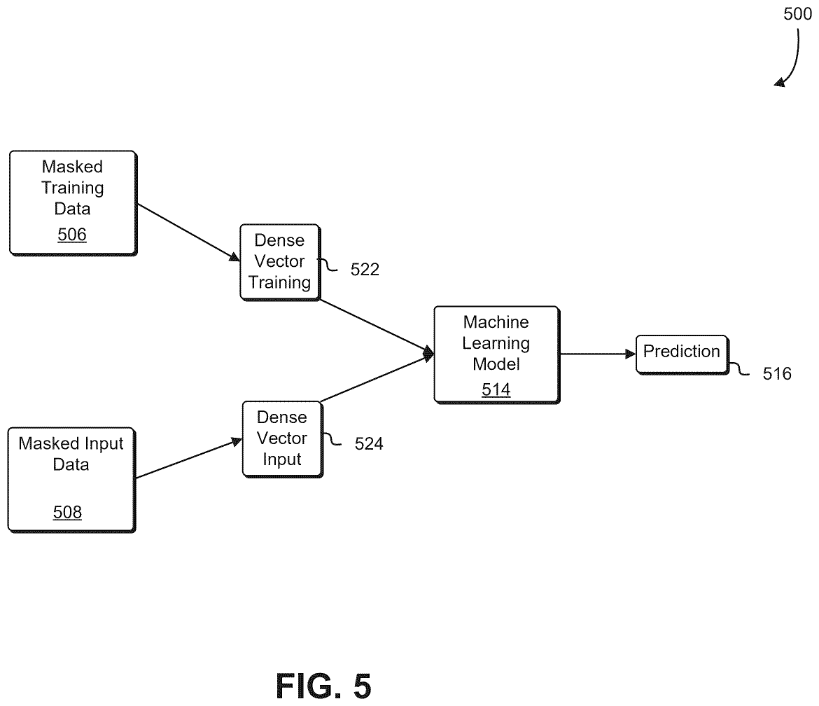

FIG. 5 illustrates an example 500 of an out-of-distribution (and outlier) prediction system, in accordance with an embodiment. In at least one embodiment, this out-of-distribution prediction system, which is similar to out-of-distribution prediction system 140 in FIG. 1, includes masked training data 506 and masked input data 508 that are translated into dense vector embeddings, such as dense vector training (data) 522 and dense vector input (data) 524, which are used to train a machine learning model 514. In at least one embodiment, the machine learning model generates a prediction 516 of whether a document or input data is an in-domain document and out-of-distribution document or outlier document.

In at least one embodiment, the system performs masked feature learning to train a machine learning model to detect out-of-distribution documents or outlier documents. In at least one embodiment, the system extracts a set of features from a training document, such as training data 106 in FIG. 1, to generate the masked training data 506. As described above, the system may perform visual token masking, visual patch masking, and token text masking to perform contrastive learning techniques. For example, contrastive learning is a deep learning technique using contrasting data samples against each other to learn attributes that are common between data classifications and attributes that set apart a data classification from others (e.g., a representation of data with similar instances being close together in a distribution space and dissimilar instances are set far apart).

In at least one embodiment, as a result of performing feature masking, the system generates the masked training data 506. In at least one embodiment, the masked training data 506 may include features from pixel image data, plaintext data, or layout data, or a combination of either image, plaintext, or layout data. In at least one embodiment, these features include a set of features that result from omitting some features from both in-distribution training documents and out-of-distribution documents. In at least one embodiment, some features that are omitted from training material to generate the masked training data 506 may include features that are common to both in-distribution training documents and out-of-distribution documents. For example, if some of these features that are common, to both in-distribution and out-of-distribution documents, were left in the training material, it may serve little purpose in learning contrasting features of various classifications of training documents.

In at least one embodiment, the system translates the masked training data 506 into dense vector training data 522 to train the machine learning model 514. In at least one embodiment, the dense vector training 522 may is an array of numbers with each element has a significant value. For example, in a random sentence, each word will have a significant value represented in a dense vector and may be used to learn other words in the sentence (“neighbors”). In at least one embodiment, a training document (or input document) that may include plaintext data, image data, or layout data (or combination thereof) goes through an embedding layer and is converted into this dense vector training 552 alternatively known as a dense embedding vector. In at least one embodiment, the masked training data 506 includes features of a training document that concatenated together to generate the dense vector training 522. In at least one embodiment, the dense (embedding) vector training 522 are encoded and processed in the machine learning model 514.

In at least one embodiment, the dense vector training 522 may be a training forward propagation used to train the machine learning model 514. In at least one embodiment, the training forward propagation may include a storage of variables for input to the machine learning model 514. In at least one embodiment, the training forward propagation may include output of the machine learning model 514.

In at least one embodiment, the system extracts a set of features from an input document to generate the masked training data 506. The input document is similar to documents 108 in FIG. 1 and documents 208 in FIG. 2. In at least one embodiment, the system receives the input document to be processed by the machine learning model 514 to generate the prediction 516. In at least one embodiment, the system translates the masked input data 508 into dense vector input data 524 to be used by the machine learning model 514 to generate an inference. Here, the machine learning model 514 generates a prediction 516 of whether the input document is an in-distribution or out-of-distribution document. In at least one embodiment, the dense vector input 524 is similar to the dense vector training 522, described above.

In at least one embodiment, the prediction 516 is an output of the machine learning model 514. In at least one embodiment, the prediction 516 may be a classification of an input document, such as documents 108 in FIG. 1, that the machine learning model is trained to classify. In at least one embodiment, the prediction 516 may be generated by the machine learning model 514 by using a threshold value on model confidence scores as a decision boundary to classify an unknown document into in-domain or out-of-distribution. The confidence scores may be generated during training of the machine learning model. In at least one embodiment, the prediction 516 may generated by calculating a distance score according to a Mahalanobis distance method, such as by calculating the distance between an extracted dense vector, such as dense vector input 524 of the document associated with the masked input data 508 and classification conditional Gaussian distributions learned by the machine learning model 514 during training. In at least one embodiment, the prediction 516 is generated by using a combination of the threshold value of the confidence scores and the distance score.

In at least one embodiment, parts, methods and/or systems described in connection with FIG. 5 are as further illustrated non-exclusively in any of FIGS. 1-8.

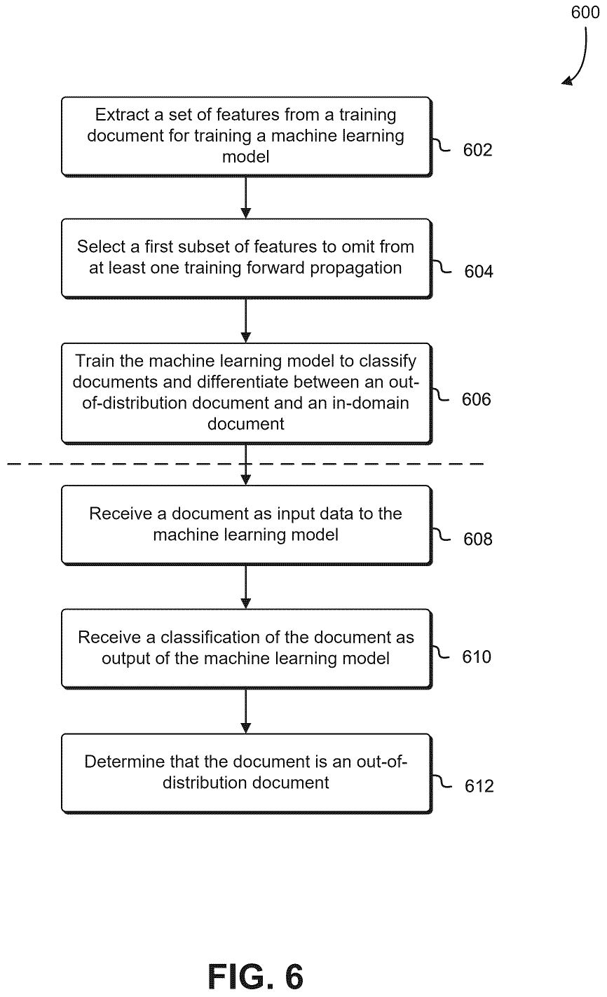

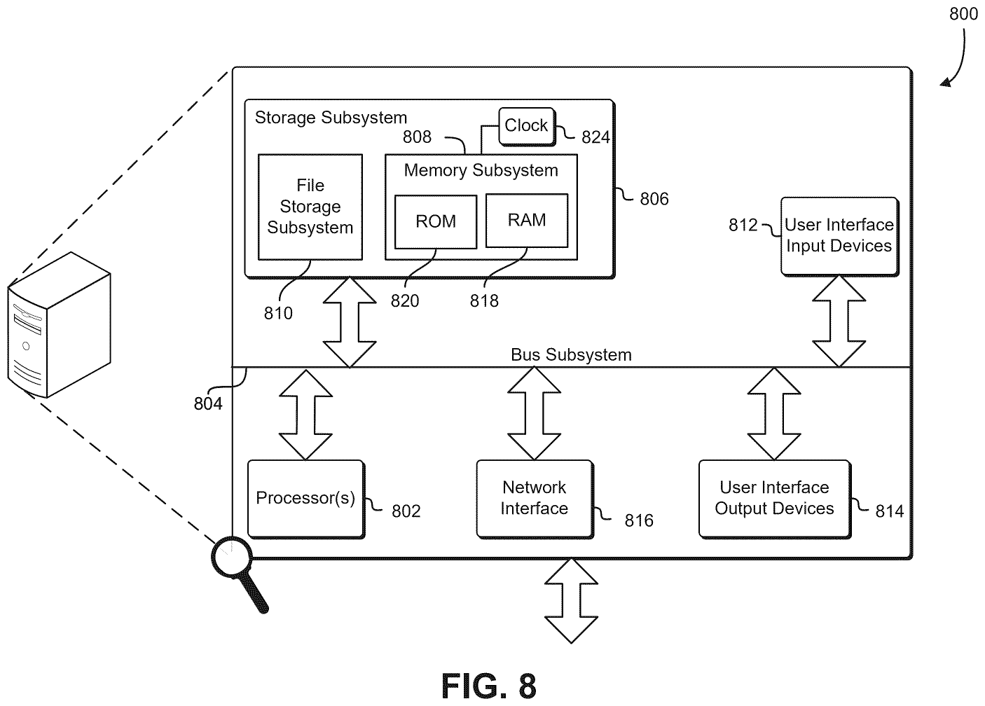

FIG. 6 is flowchart illustrating an example of an out-of-distribution prediction system that trains a machine learning model to identify whether a data object is out-of-distribution, in accordance with an embodiment. Some or all of the process 600 (or any other processes described, or variations and/or combinations of those processes) may be performed by one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 600 may be performed by any suitable system, such as the computing device 800 of FIG. 8. The process 600 includes a series of operations wherein the system is performing process 600 extract features from a training document, select features to mask from the training document to create masked training data, and train a machine learning model using the masked training data to detect an out-of-distribution document.

In 602, in at least one embodiment, one or more processors of the out-of-distribution prediction system, or alternatively known as a computing system or system, extract features from a training document for training a machine learning model. In at least one embodiment, the features are extracted from the training document using a feature extraction module such as the feature extraction module 110 in FIG. 1. In at least one embodiment, the features may include plaintext, image, and/or layout data.

In 604, in at least one embodiment, one or more processors of the out-of-distribution prediction system select a subset of features to omit from a training forward propagation. In at least one embodiment, the one or more processors select the subset of features from the set of features extracted from the training document. In at least one embodiment, the subset of features to omit or mask may be determined based on a pseudorandom process. In at least one embodiment, a pseudorandom process to omit features may include masking plaintext data, input data, or layout data, or a combination thereof in a stochastically distributed manner. In at least one embodiment, the pseudorandom process to omit features includes pseudorandomly determining data in a training document to mask for training the machine learning model. In at least one embodiment, the pseudorandom process to omit features includes pseudorandomly determining data in a document to mask that is to be classified during inferencing operations. In at least one embodiment, the pseudorandom process to omit features includes pseudorandomly determining data to mask in training operations of the machine learning model and in inferencing operations of the machine learning model. In this disclosure, for example, the system masks different parts of a document in a statistically random manner, so that masking performed over time results in predictions of documents with features that are expected for a given in domain classification and remaining features are unknown, creating greater separation between in domain and out-of-distribution data.

In some embodiments, the pseudorandom process to omit features result in more robust predictions of in domain documents by training the machine learning model with in domain documents that have much more relevant features (for what the model is trained to predict) than out-of-distribution documents. In some embodiments, the pseudorandom process to omit features includes pseudorandomly selecting features to mask that are common to in domain and out-of-distribution documents. For example, to training a model to predict whether a document is a passport or a national identification (both in domain classifications), the system may mask features of name and date of birth, which are features also found in a driver's license that in this example is out-of-distribution. This masking of common features would result in a greater separation between features remaining in “in domain” documents and features in out-of-distribution documents that are irrelevant for passports or national identifications (e.g., a license #, a medical condition, or if the person is registered as an organ donor.)

In at least one embodiment, the subset of features to omit may be determined based on selecting features of a training document or new document (e.g., input data) at consistent (e.g., approximately the same) location in the documents. In at least one embodiment, the subset of features to omit may be determined by using a percentage or number (e.g., a parameter) specified by a user, client device, computer system, hardware, or software application of the system.

In 606, in at least one embodiment, one or more processors of the out-of-distribution prediction system train the machine learning model to produce a trained machine learning model, by using another subset of the features, from the training document, in the training forward propagation. In at least one embodiment, the other subset of the features is different from the subset of features that are omitted from the training forward propagation (e.g., the other subset of features is disjoint from the omitted subset of features). In some embodiments, a subset of features is disjoint from another subset of features when neither of the subsets have any features in common. In some embodiments, the subset of features is disjoint from another subset of features if there is no “intersection” or “overlap” between the two subsets of features. For example, a set of features {1, 3, 5, 7} is disjoint from another set of features {2, 4, 6, 8}, as none of the features or elements of the two sets of features are in common. In at least one embodiment, a training forward propagation includes a process of passing (“propagating”) input data through a network (e.g., neural network) and generating an output (e.g., prediction). In at least one embodiment, the trained machine learning model outputs information usable to classify documents, such as documents 108 in FIG. 1. In at least one embodiment, the trained machine learning model outputs information usable to differentiate between an out-of-distribution document and an in-distribution document (alternatively known as an in-domain document) In at least one embodiment, the system trains the machine learning model using a masked training document to produce a trained machine learning model.

The dashed line indicates a separation in the process 600 between training the machine learning model and using the machine learning model.

In 608, in at least one embodiment, one or more processors of the out-of-distribution prediction system receives a document as input data to the machine learning model. In at least one embodiment, a processor of the out-of-distribution system performs operations to mask at least a portion of the input data to produce a masked input data. In at least one embodiment, the processor performs operations to provide the masked input data to the trained machine learning model as input.

In 610, in at least one embodiment, one or more processors of the out-of-distribution prediction system perform operations to receive a classification of the document as an output of the machine learning model. In at least one embodiment, the classification is generated by the system extracting a dense vector embedding of the document, comparing it to an in-domain dense vector embedding to obtain a confidence score, and then comparing that confidence score to a threshold value of confidence scores, obtained during the training of the machine learning model.

In 612, in at least one embodiment, one or more processors of the out-of-distribution prediction system perform instructions to determine that the document is an out-of-distribution document. In at least one embodiment, the processor may perform operations to cause the out-of-distribution document to be sent for manual review. In at least one embodiment, the manual review may be performed by a user of the out-of-distribution system, such as user 102 in FIG. 1, or by any entity designated as an in-domain data expert.

In at least one embodiment, parts, methods and/or systems described in connection with FIG. 6 are as further illustrated non-exclusively in any FIG. 1-8. Note that one or more of the operations performed in 602-14 may be performed in various orders and combinations, including in parallel.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

FIG. 7 is a block diagram illustrating driver and/or runtime software comprising one or more libraries to provide one or more application programming interfaces (APIs), in accordance with at least one embodiment. In at least one embodiment, a software program 702 is a software module. In at least one embodiment, a software program 702 comprises one or more software modules. In at least one embodiment, one or more APIs 710 are sets of software instructions that, if executed, cause one or more processors to perform one or more computational operations. In at least one embodiment, one or more APIs 710 are distributed or otherwise provided as a part of one or more libraries 706, runtimes 704, drivers 704, and/or any other grouping of software and/or executable code further described herein. In at least one embodiment, one or more APIs 710 perform one or more computational operations in response to invocation by software programs 702. In at least one embodiment, a software program 702 is a collection of software code, commands, instructions, or other sequences of text to instruct a computing device to perform one or more computational operations and/or invoke one or more other sets of instructions, such as APIs 710 or API functions 712, to be executed. In at least one embodiment, functionality provided by one or more APIs 710 includes software functions 712, such as those usable to accelerate one or more portions of software programs 702 using one or more parallel processing units (PPUs), such as graphics processing units (GPUs). In at least one embodiment, a software program is a compiler.

In at least one embodiment, APIs 710 are hardware interfaces to one or more circuits to perform one or more computational operations. In at least one embodiment, one or more software APIs 710 described herein are implemented as one or more circuits to perform one or more techniques described below in conjunction with FIGS. 2-6. In at least one embodiment, one or more software programs 702 comprise instructions that, if executed, cause one or more hardware devices and/or circuits to perform one or more techniques further described below in conjunction with FIGS. 2-6.

In at least one embodiment, software programs 702, such as user-implemented software programs, utilize one or more application programming interfaces (APIs) 710 to perform various computing operations, such as memory reservation, matrix multiplication, arithmetic operations, or any computing operation performed by parallel processing units (PPUs), such as graphics processing units (GPUs), as further described herein. In at least one embodiment, one or more APIs 710 provide a set of callable functions 712, referred to herein as APIs, API functions, and/or functions, that individually perform one or more computing operations, such as computing operations related to parallel computing. For example, in an embodiment, one or more APIs 710 provide functions 712 to cause an out-of-distribution system 716 to generate a prediction and determine, based on the prediction, that input data is out-of-distribution.

In at least one embodiment, one or more software programs 702 interact or otherwise communicate with one or more APIs 710 to perform one or more computing operations using one or more PPUs, such as GPUs. In at least one embodiment, one or more computing operations using one or more PPUs comprise at least one or more groups of computing operations to be accelerated by execution at least in part by the one or more PPUs. In at least one embodiment, one or more software programs 702 interact with one or more APIs 710 to facilitate parallel computing using a remote or local interface.

In at least one embodiment, an interface is software instructions that, if executed, provide access to one or more functions 712 provided by one or more APIs 710. In at least one embodiment, a software program 702 uses a local interface when a software developer compiles the one or more software programs 702 in conjunction with one or more libraries 706 comprising or otherwise providing access to one or more APIs 710. In at least one embodiment, one or more software programs 702 are compiled statically in conjunction with pre-compiled libraries 706 or uncompiled source code comprising instructions to perform one or more APIs 710. In at least one embodiment, one or more software programs 702 are compiled dynamically and the one or more software programs utilize a linker to link to one or more pre-compiled libraries 706 comprising one or more APIs 710.

In at least one embodiment, a software program 702 uses a remote interface when a software developer executes a software program that utilizes or otherwise communicates with a library 706 comprising one or more APIs 710 over a network or other remote communication medium. In at least one embodiment, one or more libraries 706 comprising one or more APIs 710 are to be performed by a remote computing service, such as a computing resource services provider. In another embodiment, one or more libraries 706 comprising one or more APIs 710 are to be performed by any other computing host providing the one or more APIs 710 to one or more software programs 702.

In at least one embodiment, a processor performing or using one or more software programs 702 calls, uses, performs, or otherwise implements one or more APIs 710 to allocate and otherwise manage memory to be used by the software programs 702. In at least one embodiment, one or more software programs 702 utilize one or more APIs 710 to allocate and otherwise manage memory to be used by one or more portions of the software programs 702 to be accelerated using one or more PPUs, such as GPUs or any other accelerator or processor further described herein. Those software programs 702 request an out-of-distribution prediction system 716 receive and API call to receive training data, mask the training data, train a machine learning model using the masked training data, receive input data, mask the input data, provide the masked data to the machine learning model, receive a prediction, and determine that the input data is out-of-distribution using functions 712 provided, in an embodiment, by one or more APIs 710.

In at least one embodiment, an API 710 is an API to facilitate parallel computing. In at least one embodiment, an API 710 is any other API further described herein. In at least one embodiment, an API 710 is provided by driver and/or runtime software 704. In at least one embodiment, an API 710 is provided by a CUDA user-mode driver. In at least one embodiment, an API 710 is provided by a CUDA runtime. In at least one embodiment, driver and/or runtime software 704 is data values and software instructions that, if executed, perform or otherwise facilitate operation of one or more functions 712 of an API 710 during load and execution of one or more portions of a software program 702. In at least one embodiment, a runtime 704 is data values and software instructions that, if executed, perform, or otherwise facilitate operation of one or more functions 712 of an API 710 during execution of a software program 702. In at least one embodiment, one or more software programs 702 utilize one or more APIs 710 implemented or otherwise provided by driver and/or runtime software 704 to perform combined arithmetic operations by the one or more software programs 702 during execution by one or more PPUS, such as GPUs.

In at least one embodiment, one or more software programs 702 utilize one or more APIs 710 provided by driver and/or runtime software 704 to perform combined arithmetic operations of one or more PPUs, such as GPUs. In at least one embodiment, one or more APIs 710 provide combined arithmetic operations through driver and/or runtime software 704, as described above. In at least one embodiment, one or more software programs 702 utilize one or more APIs 710 provided by driver and/or runtime software 704 to allocate or otherwise reserve one or more blocks of memory 714 of one or more PPUs, such as GPUs. In at least one embodiment, one or more software programs 702 utilize one or more APIs 710 provided by driver and/or runtime software 704 to allocate or otherwise reserve blocks of memory. In at least one embodiment, one or more APIs 710 are to perform combined arithmetic operations, as described below in conjunction with any of FIGS. 1-6.

To improve software programs 702 usability and/or optimization of one or more portions of the software programs 702 to be accelerated by one or more PPUs, such as GPUs, in an embodiment, one or more APIs 710 provide one or more API functions 712 to perform a neural network usable or used by one or more computing devices as described above and further described below in conjunction with FIGS. 1-6. In at least one embodiment, an exemplary block diagram 700 depicts a processor, comprising one or more circuits to perform one or more software programs to combine two or more application programming interfaces (APIs) into a single API. In at least one embodiment, an exemplary block diagram 700 depicts a system, comprising one or more processors to perform one or more software programs to combine two or more application programming interfaces (APIs) into a single API. In at least one embodiment, a processor uses an API to cause out-of-distribution prediction system 716 to receive a request to generate a prediction and determine, based on the prediction, that input data is out-of-distribution. In at least one embodiment, an exemplary block diagram 700 illustrates an API to invoke an out-of-distribution system to cause an input data determined to be out-of-distribution to be manually reviewed.

In at least one embodiment, parts, methods and/or a system described in connection with FIG. 7 are as further illustrated non-exclusively in any FIG. 1-8.

FIG. 8 is an illustrative, simplified block diagram of a computing device 800 that can be used to practice at least one embodiment of the present disclosure. In various embodiments, the computing device 800 includes any appropriate device operable to send and/or receive requests, messages, or information over an appropriate network and convey information back to a user of the device. The computing device 800 may be used to implement any of the systems illustrated and described above. For example, the computing device 800 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 800 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 8, the computing device 800 may include one or more processors 802 that, in embodiments, communicate with and are operatively coupled to a number of peripheral subsystems via a bus subsystem. In some embodiments, these peripheral subsystems include a storage subsystem 806, comprising a memory subsystem 808 and a file/disk storage subsystem 810, one or more user interface input devices 812, one or more user interface output devices 814, and a network interface subsystem 816. Such storage subsystem 806 may be used for temporary or long-term storage of information.

In some embodiments, the bus subsystem 804 may provide a mechanism for enabling the various components and subsystems of computing device 800 to communicate with each other as intended. Although the bus subsystem 804 is shown schematically as a single bus, alternative embodiments of the bus subsystem utilize multiple buses. The network interface subsystem 816 may provide an interface to other computing devices and networks. The network interface subsystem 816 may serve as an interface for receiving data from and transmitting data to other systems from the computing device 800. In some embodiments, the bus subsystem 804 is utilized for communicating data such as details, search terms, and so on. In an embodiment, the network interface subsystem 816 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well known and will not be discussed in detail. In an embodiment, communication via the network interface subsystem 816 is enabled by wired and/or wireless connections and combinations thereof.

In some embodiments, the user interface input devices 812 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 800. In some embodiments, the one or more user interface output devices 814 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 800. The one or more user interface output devices 814 can be used, for example, to present user interfaces to facilitate user interaction with applications performing processes described and variations therein, when such interaction may be appropriate.

In some embodiments, the storage subsystem 806 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 806. These application modules or instructions can be executed by the one or more processors 802. In various embodiments, the storage subsystem 806 additionally provides a repository for storing data used in accordance with the present disclosure. In some embodiments, the storage subsystem 806 comprises a memory subsystem 808 and a file/disk storage subsystem 810.

In embodiments, the memory subsystem 808 includes a number of memories, such as a main random-access memory (RAM) 818 for storage of instructions and data during program execution and/or a read only memory (ROM) 820, in which fixed instructions can be stored. In some embodiments, the file/disk storage subsystem 810 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 800 includes at least one local clock 824. The at least one local clock 824, in some embodiments, is a counter that represents the number of ticks that have transpired from a particular starting date and, in some embodiments, is located integrally within the computing device 800. In various embodiments, the at least one local clock 824 is used to synchronize data transfers in the processors for the computing device 800 and the subsystems included therein at specific clock pulses and can be used to coordinate synchronous operations between the computing device 800 and other systems in a data center. In another embodiment, the local clock is a programmable interval timer.

The computing device 800 could be of any of a variety of types, including a portable computer device, tablet computer, a workstation, or any other device described below. Additionally, the computing device 800 can include another device that, in some embodiments, can be connected to the computing device 800 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 800 for processing. Due to the ever-changing nature of computers and networks, the description of the computing device 800 depicted in FIG. 8 is intended only as a specific example for purposes of illustrating the preferred embodiment of the device. Many other configurations having more or fewer components than the system depicted in FIG. 8 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object level interfaces. The computing device 800 may include any appropriate hardware, software and firmware for integrating with a data store as needed to execute aspects of one or more applications for the computing device 800 to handle some or all of the data access and business logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 800 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 800 may provide access to content including, but not limited to, text, graphics, audio, video, and/or other content that is provided to a user in the form of HyperText Markup Language (HTML), Extensible Markup Language (XML), JavaScript, Cascading Style Sheets (CSS), JavaScript Object Notation (JSON), and/or another appropriate language. The computing device 800 may provide the content in one or more forms including, but not limited to, forms that are perceptible to the user audibly, visually, and/or through other senses. The handling of requests and responses, as well as the delivery of content, in an embodiment, is handled by the computing device 800 using PHP: Hypertext Preprocessor (PHP), Python, Ruby, Perl, Java, HTML, XML, JSON, and/or another appropriate language in this example. In an embodiment, operations described as being performed by a single device are performed collectively by multiple devices that form a distributed and/or virtual system.

In an embodiment, the computing device 800 typically will include an operating system that provides executable program instructions for the general administration and operation of the computing device 800 and includes a computer-readable storage medium (e.g., a hard disk, random access memory (RAM), read only memory (ROM), etc.) storing instructions that if executed (e.g., as a result of being executed) by a processor of the computing device 800 cause or otherwise allow the computing device 800 to perform its intended functions (e.g., the functions are performed as a result of one or more processors of the computing device 800 executing instructions stored on a computer-readable storage medium).

In an embodiment, the computing device 800 operates as a web server that runs one or more of a variety of server or mid-tier applications, including Hypertext Transfer Protocol (HTTP) servers, FTP servers, Common Gateway Interface (CGI) servers, data servers, Java servers, Apache servers, and business application servers. In an embodiment, computing device 800 is also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python, or TCL, as well as combinations thereof. In an embodiment, the computing device 800 is capable of storing, retrieving, and accessing structured or unstructured data. In an embodiment, computing device 800 additionally or alternatively implements a database, such as one of those commercially available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

1. A system for detecting out-of-domain documents, comprising:
one or more processors; and
memory storing computer-executable code that, as a result of execution by the one or more processors, cause the system to at least:
identify a common feature between both an out-of-domain machine learning training document and an in-domain machine learning training document;
extract a set of features for at least one machine learning training forward propagation, the set of features including features of the out-of-domain machine learning training document and the in-domain machine learning training document;
mask the common feature so as to exclude at least part of the common feature from the set of features, wherein masking the common feature comprises tokenizing and modifying the common feature to perform attention masking on at least part of the set of features corresponding to the common feature; and
train, using the set of features that exclude at least part of the common feature in the at least one machine learning training forward propagation, a machine learning model to produce a trained machine learning model that predicts whether an input document is out-of-domain.

2. The system of claim 1, wherein the computer-executable code that causes the system to produce the trained machine learning model includes executable code that causes the system to compare a first embedding associated with one or more in-domain documents to a second embedding associated with one or more OOD documents.

3. The system of claim 1, wherein the set of features includes in-domain data and OOD data.

4. The system of claim 1, wherein the computer-executable code that causes the system to extract the set of features includes executable code that causes the system to:
select the common feature to omit from one of either the OOD training document or an in-domain training document.

5. The system of claim 1, wherein the computer-executable code that causes the system to extract the set of the features includes executable code that causes the system to select portions of the set of features at a same location in at least two training forward propagation of a plurality of training forward propagations.

6. The system of claim 1, wherein the computer-executable code that causes the system to extract the set of the features includes executable code that causes the system to:
identify a particular feature that is repeatedly activated in encoding layers during training of the machine learning model as being associated with one or more classifications; and
include the particular feature in the set of features.

7. The system of claim 1, wherein the computer-executable code that causes the system to produce the trained machine learning model includes executable code that causes the system to train the machine learning model using one or both of:
a confidence measure associated with information used to predict whether the input document is out-of-domain, or
a distance metric associated with the information.

8. A computer-implemented method, comprising:
identifying a common feature to both an out-of-domain document and an in-domain document;
selecting a set of features for at least one training forward propagation, the set of features of both the out-of-domain document and the in-domain document;
masking the common feature so as to exclude at least part of the common feature from the set of features, wherein masking the common feature comprises tokenizing and modifying the common feature to perform attention masking on at least part of the set of features corresponding to the common feature; and
training, using the set of features that exclude at least part of the common feature in the at least one training forward propagation, a machine learning model to produce a trained machine learning model that classifies documents and distinguishes between OOD documents and in-domain documents.

9. The computer-implemented method of claim 8, wherein selecting the set of the features of training data is performed based, at least in part, on using a pseudorandom process.

10. The computer-implemented method of claim 8, wherein selecting the set of the features includes:
obtaining a constraint that specifies a size or number of portions of the set of features to be omitted; and
omitting the set of features in accordance with the constraint.

11. The computer-implemented method of claim 8, further comprising:
receiving a document as an input to the trained machine learning model;
receiving a classification of the document as an output of the trained machine learning model; and
determining, based at least in part on the classification, that the document is OOD.

12. The computer-implemented method of claim 8, wherein training the machine learning model includes generating a threshold of confidence measures associated with a plurality of training documents used in training the machine learning model.

13. The computer-implemented method of claim 8, wherein the training the machine learning model includes generating a distance metric using a Mahalanobis distance algorithm.

14. The computer-implemented method of claim 8, wherein a training document, from which the set of features are extracted, includes at least one of:
plaintext data,
image data, or
layout data.

15. A non-transitory computer-readable storage medium storing computer-executable instructions that, as a result of being executed by one or more processors of a computer system, cause the computer system to at least:
identify a feature common to both an out-of-domain (OOD) training document and an in-domain training document;
select a set of features for at least one machine learning training forward propagation, the set of features including features of both the out-of-domain (OOD) training document and the in-domain training document
mask the feature common to both so as to exclude at least part of the feature common to both from the set of features, wherein masking the feature common to both comprises tokenizing and modifying the feature common to both to perform attention masking on at least part of the set of features corresponding to the feature common to both; and
train, using the set of features that exclude at least part of the feature common to both in the at least one machine learning training forward propagation, a machine learning model that distinguishes between OOD documents and an in-domain documents.

16. The non-transitory computer-readable storage medium of claim 15, wherein the training document includes one or more of:
textual information,
image information, or
layout information.

17. The non-transitory computer-readable storage medium of claim 15, wherein the computer-executable instructions that cause the computer system to select the set of features include executable instructions that cause the computer system to determine which features of the set of features to omit by causing the computer system to at least:
select the features according to a pseudorandom process,
select the features from a same location in the training document and in other training documents that are used for training the machine learning model, or
select the features that are associated with one or more weights by the machine learning model based at least in part on identifying one or more features that are activated and associated with one or more classifications, the one or more features being activated at a frequency that exceeds a threshold.

18. The non-transitory computer-readable storage medium of claim 15, wherein the computer-executable instructions that cause the computer system to select the set of features include executable instructions that cause the computer system to determine the features to omit by causing the computer system to:
select a first feature of the training document that is associated with a weight;
select a second feature of the training document pseudorandomly; and
the features to omit include the first and second features.

19. The non-transitory computer-readable storage medium of claim 15, wherein the set of features is omitted from the at least the one machine learning training forward propagation by using a computer-generated shape to obfuscate the set of features within the computer-generated shape.

20. The non-transitory computer-readable storage medium of claim 15, wherein the computer-executable instructions that cause the computer system to select the set of features include executable instructions that cause the computer system to:
identify a particular feature that is repeatedly activated in encoding layers during machine learning model training; and
include the particular feature in the set of features.

21. The system of claim 1, wherein the attention masking comprises adding one or more padded tokens to the common feature.

22. The system of claim 1, wherein the computer-executable code that, as a result of execution by the one or more processors, further causes the system to translate at least some of the set of features into dense vector embeddings that are used to train the machine learning model.
